(19) United States
(12) Patent Application Publication
(10) Pub. No.: US 2007/0300013 A1
(43) Pub. Date: Dec. 27, 2007

(54) Storage system having transaction monitoring capability

(76) Inventor: Manabu Kitamura, Asao-ku (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/471,558

(22) Filed: Jun. 21, 2006

(51) Int. Cl. G06F 12/16; G06F 12/14

(52) U.S. Cl. 711/114; 711/163

(57) ABSTRACT

A system and method for managing transactions of application programs at a storage system enables data protection on a per-transaction basis. The storage system receives an instruction indicating a beginning of a transaction, and determines at least one primary volume for receiving data for the transaction. The storage system also provides a log volume for initially storing write data designated for the primary volume associated with the transaction. When the transaction is successfully completed the data stored in the log volume for the transaction is applied to the primary volume.

### BACKGROUND OF THE INVENTION

1. Field of the Invention

The present invention relates generally to storage systems, and, more particularly, to a method for simultaneously handling a plurality of data access requests while enabling data protection.

2. Description of Related Art

Continuous Data Protection (CDP)

Continuous data protection (CDP) provides a storage system in which the data is backed up whenever any change is made to the data. Continuous data protection is different from traditional data backup in that it is not necessary for a user to specify the point in time at which the user would like to recover data until the user is actually ready to perform a restore operation. Traditional data backup systems are only able to restore data to certain discrete points in time at which backups were made, such as one hour, one day, one week, etc. However, with continuous data protection, there are no backup schedules. Rather, when data is written to disk, it is also asynchronously written to a second location, such as another storage system over a network. This introduces some overhead to disk-write operations but eliminates the need for nightly scheduled backups, or the like.

Thus, the basic purpose of CDP is to enable recovery of data at any desired or essential point in time when it becomes necessary for data to be recovered. In effect, CDP creates a continuous journal or log of complete storage snapshots, i.e., one storage snapshot for every instant in time that data modification occurs. In the CDP method, storage systems, backup software in host computers, or other hardware or software captures write I/Os from host computer file systems, and records all of the write I/Os as a log (sometimes called the “journal”). Also when CDP is started, the system initially preserves a snapshot copy of the production volumes (i.e., the volumes for which the users want to have the data backed up), which is the initial image of the volumes when CDP is started. When recovering data, by applying the journal against the initial image of the volumes, the CDP method enables recovery of data at any point when write I/Os were made to the primary volumes.

CDP systems may be either block-based or file-based systems. Block-based systems operate at the block level of logical devices so that as data blocks are written to a primary storage volume, copies of the data being written are stored to the journal, along with a timestamp and some form of location data. Application-level integration is through APIs (Application Programming Interfaces, such as Oracle and SQL Server). The integration through APIs is usually necessary for data consistency.

File-based solutions operate in a manner similar to block-based solutions. However, file-based CDP solutions are often able to recover data at the file level rather than having to recover the whole volume. Furthermore, there is no common file-level solution across all platforms, so file-level systems can only be applied to specific applications and platforms.

Thus, a major advantage of CDP is that a record is made of every transaction that takes place in the storage system. Furthermore, if the storage system becomes contaminated with a virus, or if a file in the system is corrupted or accidentally deleted, and the problem is not discovered until some time later, a user is still able to recover the most recent uncorrupted version of the file. Additionally, a CDP system set up on a disk array storage system enables data recovery in a matter of seconds, which is considerably less time than is possible with tape backups or archives.

Application Program Transactions

Application programs usually execute operations that include several requests or data updates or other tasks that together make up a discrete unit of work. Each of these discrete units of work may be referred to as a “transaction”. Transactions typically are a group of logical operations that must all succeed or fail as a group. Thus, for a transaction to be completed successfully, each task of the multiple tasks forming part of the transaction should be completed successfully. For example, withdrawing money from an ATM (automated teller machine) may appear to the customer to be a single operation; however, this can actually be considered as a transaction having two main operations: (1) the money must be dispensed and (2) the client's bank account must be debited for the amount dispensed. If the money is dispensed without debiting the customer's account, the bank loses the money. Therefore, both operations must take place for the transaction to be complete. Further, each of these two main operations will include a number of sub-operations. Thus, all of these sub-operations must also be completed for the transaction to be successful.

Because each type of transaction is a concept defined specifically within each application program, that is, within a host computer or a set of host computers where each of the application programs run, storage systems are usually unable to distinguish whether an I/O operation is the start, middle or end of a transaction for a particular application program. Therefore even when storage systems have the capability of recovering data at each I/O, such as through CDP, the recovered data might be useless unless the data is recovered according to its state at the end of a transaction or at the beginning of a transaction.

The following US patent application Publications teach CDP concepts and methods in which the basic functions are performed in the storage system, and the disclosures of these documents are incorporated herein by reference in their entireties: US 2004/0268067 to Yamagami, entitled “Method and Apparatus for Backup and Recovery System using Storage Based Journaling”; US 2005/0015416 to Yamagami, entitled “Method and Apparatus for Data Recovery using Storage Based Journaling”; US 2005/0022213 to Yamagami, entitled “Method and Apparatus for Synchronizing Applications for Data Recovery using Storage Based Journaling”; US 2005/0028022 to Amano, entitled “Method and Apparatus for Data Recovery System using Storage Based Journaling”; and US 2005/0235016 to Amano et al., entitled “Method and Apparatus for Avoiding Journal Overflow on Backup and Recovery System using Storage Based Journaling. However, none of these applications disclose how to manage a transaction that is composed of a plurality of requests or actions by a plurality of application programs.

In an environment where a plurality of application programs are running, to completely handle data consistency, there are two ways of handling the data: 1) all application programs can handle data consistency and all application programs collaborate with each other to manage transactions, or 2) the storage system has the capability to handle transactions. Because under the first choice (1), all application programs would have to be modified to be compatible with each other, it is preferable to adopt the second choice (2) and allow the storage system to manage data consistency. However, in an environment where one or more host computers exist and multiple application programs are running, storage systems usually do not know which I/O operation is the start or end of the transaction for the application programs. Therefore, there is a need for the ability to recover data at the start or at the end of a transaction.

### BRIEF SUMMARY OF THE INVENTION

Under one aspect, the present invention provides a method for managing transactions at the storage system, and for recovering data in the storage system at any point in time from the beginning or ending of a transaction from an application program perspective. The storage system of this invention includes means for receiving information about the beginning of a transaction and/or end of a transaction from multiple application programs. When the storage system receives a notification indicating the beginning of a transaction, the update I/O operations are recorded to a log disk. When the storage system receives the notification of the end of a transaction, the recorded data in the log disk is applied to the working volume.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a system in which the method and apparatus of a first embodiment of the invention may be applied.

FIG. 2 illustrates an example of how one logical device is created from a plurality of physical devices.

FIG. 3 illustrates a functional diagram of the system illustrated in FIG. 1.

FIG. 4 illustrates a LU mapping table maintained by the storage system.

FIG. 5 illustrates a description of the transaction list in the first embodiment.

FIG. 6 illustrates the transaction management table.

FIG. 7 illustrates a list of transaction processing APIs provided by the transaction I/O driver.

FIG. 8 illustrates a list passed by the RequestTransaction function.

FIG. 9 illustrates a flow of operation in the storage system when the RequestTransaction function is called at the host.

FIG. 10 illustrates a process flow of a TP_Write request.

FIG. 11 illustrates the TP_Read process flow.

FIG. 12 illustrates the process of the commit function.

FIG. 13 illustrates the process flow of the write operation.

FIG. 14 illustrates the process flow of the read operation.

FIG. 15 illustrates an alternative embodiment in which a plurality of application programs function with the technology of the present invention.

FIG. 16 illustrates the functional relationship among the software modules on the host computer.

FIG. 17 illustrates a process flow of the initial copy operation of the replication manager.

FIG. 18 illustrates a logical structure of a log disk.

FIG. 19 illustrates a transaction list used in the third embodiment.

FIG. 20 illustrates a process flow of update copy in the primary storage system.

FIG. 21 illustrates a process flow of update copy in the secondary storage system.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention in any manner.

### First Embodiment—System Configuration

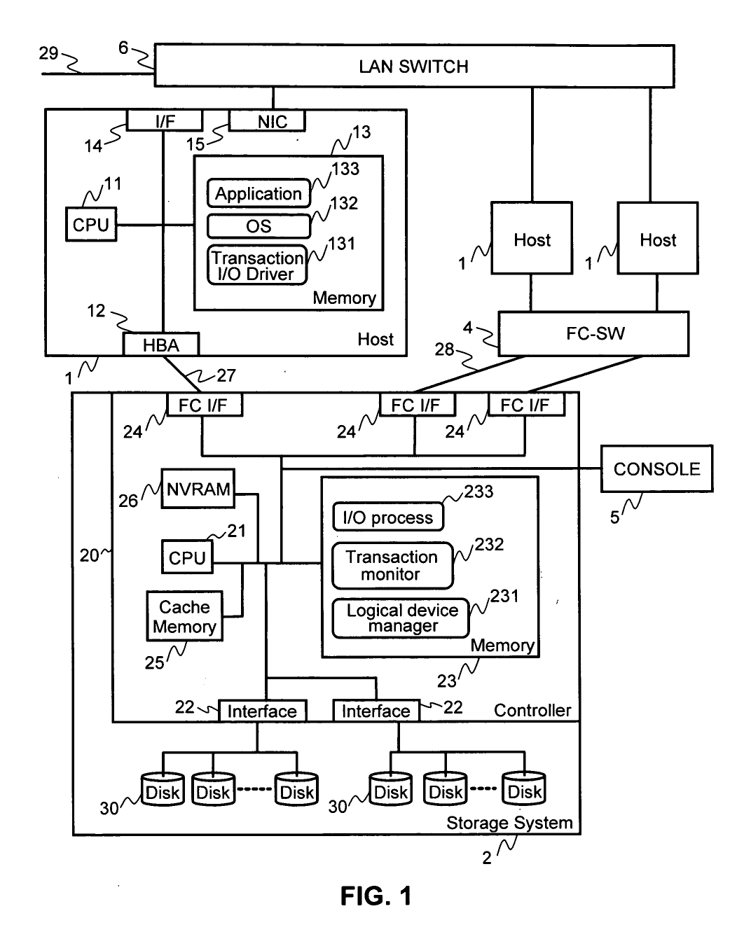

FIG. 1 illustrates an example of the system in which the method and apparatus of this invention may be applied. The system is composed of one or more host computers 1 (hereinafter referred to as “host 1”), and a storage system 2. Hosts 1 may be connected for communication with storage system 2 via a direct connection 27 or via a Fibre Channel (FC) switch (FC-SW) 4 as part of a storage area network 28. Further, hosts 1 may be able to communicate with each other via a local area network (LAN) 29 including a LAN switch 6. The physical interface of LAN switch 6 is Ethernet in this embodiment, but may be other types of networking protocols as well.

Host 1 may be a PC/AT compatible computer or workstation that runs a UNIX® or Windows® operating system. In another embodiment, host 1 may be a mainframe computer running IBM's OS/390® or z/OS® operating systems. Host 1 is composed of at least a CPU 11, a memory 13, a Network Interface Controller (NIC) 14, and a HBA (host bus adapter) 12. Host 1 stores and accesses data in the storage system 2 via HBA 12.

Disk storage system 2 includes a disk controller 20 connected to at least one physical device 30, such as a hard disk drive. Disk controller 20 includes at least a CPU 21, a memory 23, a cache memory 25, a NVRAM (nonvolatile random access memory) 26, one or more Fibre Channel (FC) interfaces 24 and one or more disk interfaces 22. These elements function as follows:

CPU 21 executes software programs for processing host I/O requests, storing and retrieving data in the physical devices 30, and the like. Details of particular programs relevant to the present invention will be described below.

Memory 23 is a computer readable medium used to store the software programs that are executed by the CPU 21, and is used to store information that is necessary for storing and managing the data stored in the physical devices 30.

Cache memory 25 is used to temporarily store the data that is written from host 1, or is used to store the data that is read by the host 1 to shorten the response time of storage system 2 to host 1. Cache memory 25 may be battery-backed-up memory so that data is preserved even if the storage system 2 fails.

NVRAM 26 is used for storing boot programs that function when the storage system is initially powered up. When storage system 2 starts booting, the programs in the NVRAM 26 are loaded into memory 23 and are executed by CPU 21.

FC interface (FC I/F) 24 connects the storage system for communication with host 1. Alternatively, FC I/F 24 may be an Ethernet interface or other interface by which storage system 2 is able to communicate data with host 1.

Disk interface 22 is used to connect at least one physical device 30 to controller 20. In the present embodiment, the disk interface 22 (hereinafter called “disk I/F 22”) is a Fibre Channel interface, and the physical device 30 is a Fiber Channel disk device that is accessed by the disk controller 20 in accordance with Fibre Channel protocol. In another implementation, the disk I/F 22 can be an ATA interface. In this case, the physical devices 30 that are ®connected to the disk I/F 22 are ATA (Serial ATA or Parallel ATA) disk devices that are accessed by the disk controller 20 in accordance with ATA protocol.

In this disclosure, several different terms are used when referring to storage devices, such as physical device, logical device, and virtual device. These terms may be generally defined as follows:

Physical devices: Physical devices 30 are preferably hard disk drives for storing data, and are FC disk drives in the preferred embodiment, although SATA disk drives or other types of disk drives may also be used. Alternatively, in certain applications, physical devices 30 might be solid state memory, optical disks, or other mass storage device.

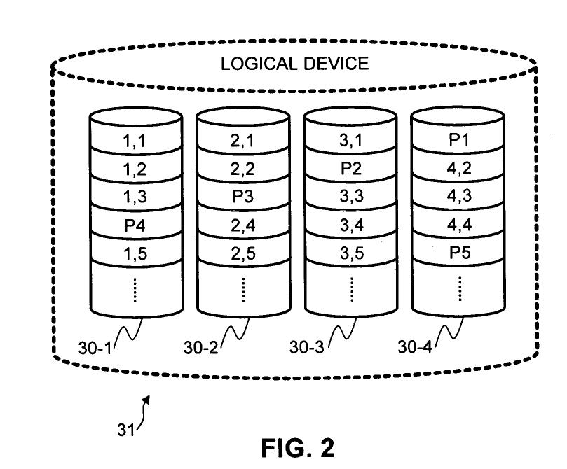

Logical devices: The disk controller 20 constructs at least one logical device using a plurality of physical devices. FIG. 2 illustrates a conceptual diagram of a logical device 31. Logical device 31 in FIG. 2 is composed of four physical devices 30 (disks 30-1, 30-2, 30-3, and 30-4). Each region labeled 1,1; 2,1; etc., is called a “stripe”. The regions labeled P1, P2, etc., are called a “parity stripe”, which is used for storing the parity data of the corresponding stripes. FIG. 2 illustrates an example in which one logical device 31 is created from a plurality of physical devices 30. In another embodiment, more than one logical device may be defined from a plurality of physical devices, or more than one logical device may be defined from one physical device.

Virtual devices: The disk controller 20 constructs at least one virtual device using at least one logical device. The virtual device is constructed to create a snapshot image of a logical device. Additional details of this will be described below.

Functional Diagram

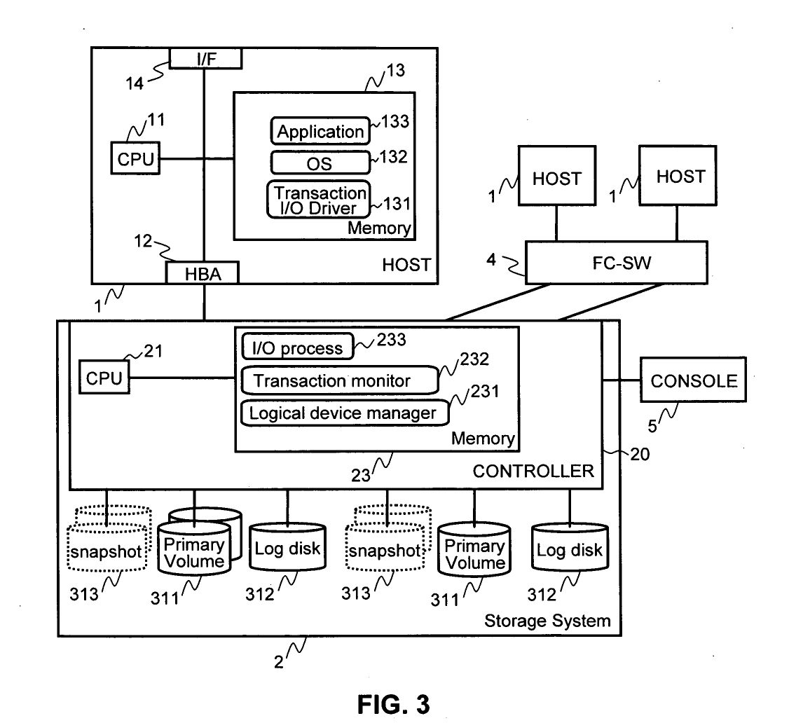

FIG. 3 illustrates a functional diagram of the system illustrated in FIG. 1. In memories 13 and 23 in the host 1 and disk controller 20, respectively, there exist multiple software modules for realizing the present invention. CPU 11 runs these software modules in host 1 and CPU 21 runs the software modules in controller 20. While these software modules are preferably stored in memories 13 and 23 when executed, they may also be stored wholly or partially on hard disk, optical disk, or other computer readable medium, either locally or remotely. The software modules executed on host 1 include an application program 133, an operating system 132, and a transaction I/O driver 131. The purpose and function of each of these software modules is as follows:

Application program 133: Application program 133 (hereinafter referred to as “application 133” or “AP 133”) is a program such as a relational database management system (RDBMS), World Wide Web server, and the like that runs on host 1 for performing a desired function.

Operating system 132: The operating system 132 provides the basic infrastructure to enable AP 133 to be executed.

Transaction I/O driver 131: This is a device driver module that is used by AP 133 when AP 133 handles a transaction. In another embodiment, transaction I/O driver 131 may be a part of OS 132. In a further embodiment, transaction I/O driver 131 may be provided as a dynamic or static link library program so that AP 133 can link to transaction I/O driver 131 as needed.

The software modules executed in controller 20 by CPU 21 include a logical device manager 231, a transaction monitor 232, and an I/O process 233. The purpose and function of each of these software modules is as follows:

Logical device manager 231: This software module defines one or more logical devices (such as logical device 31 in FIG. 2) from one or more physical devices 30. Logical device manager 231 is also able to create snapshot images of specified logical devices.

Transaction monitor 232: This module operates when the transaction processing instructions are received from host 1 via transaction I/O driver 131. Transaction monitor 232 will be described in greater detail below.

I/O process 233: This module handles I/O requests from host 1. As will be discussed in greater detail below, when transaction processing instructions are received, I/O process 233 calls the transaction monitor 232 to handle transaction processing.

Additionally, the following types of logical and virtual devices and volumes illustrated in FIG. 3 are used for carrying out the present invention:

Primary volume 311: This is a logical device that AP 133 uses to store data such as database tables, or the like, depending on the particular function of AP 133. Further, AP 133 may use more than one primary volume, or a plurality of application programs 133 may use the same primary volume or volumes.

Log disk 312: The log disk or log volume is composed of at least one logical device, and is used by the transaction monitor 232 in a manner that will be described further below.

Snapshot volume 313: A point-in-time image of the primary volume 311 is stored in the snapshot volume 313. Snapshot volume 313 is used to recover data when a transaction fails. There are a number of prior technologies that describe techniques for creating a snapshot volume, such as local mirroring or copy-on-write snapshot technology. In the present embodiment, the storage system 2 uses a copy-on-write snapshot technique to keep snapshots. Under this technique, at the point when storage system 2 needs to take a snapshot, controller 20 creates a virtual device corresponding to the primary volume 311 for storing the snapshot. When any write requests come to the primary volume 311, before updating the region designated with the write request, the data in the region is first stored to an unused logical device. Additional details of the copy-on-write snapshot operation are disclosed, for example, in U.S. Pat. No. 5,649,152, to Ohran et al., the disclosure of which is incorporated herein by reference.

How Hosts Access Logical Devices

Each logical device is managed by logical device manager 231 by assigning a unique identification number to the logical device. This unique identification number is referred to as the “logical device number” (LDEV number). Also, when host 1 accesses a logical device, it designates a port address and a LUN (Logical Unit Number). Therefore to enable host 1 to access logical devices, a set consisting of a port address and a LUN is assigned to each logical device that needs to be accessible from host 1.

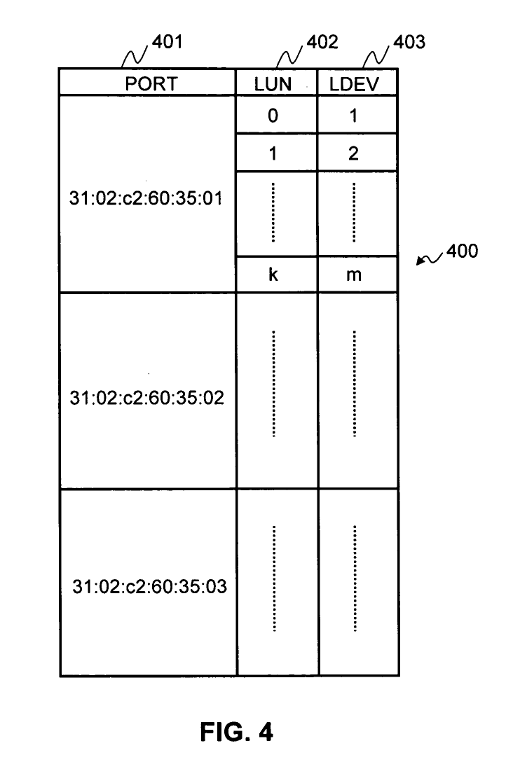

FIG. 4 illustrates a LU mapping table 400 that is maintained by the storage system 2. LU mapping table 400 maintains the combination of a port address (PORT) 401, LUN 402, and LDEV number 403 that correspond to each other. In the present embodiment, as each of the port addresses 401 is associated with one of the FC interfaces 24 in FIG. 1, a World Wide Name (WWN) in the Fibre Channel protocol is assigned to each port address 401. By using LU mapping table 400, when the storage system 2 receives an I/O command designating a port and LUN, the LDEV number of the logical device to be accessed is able to be uniquely determined.

Transaction List

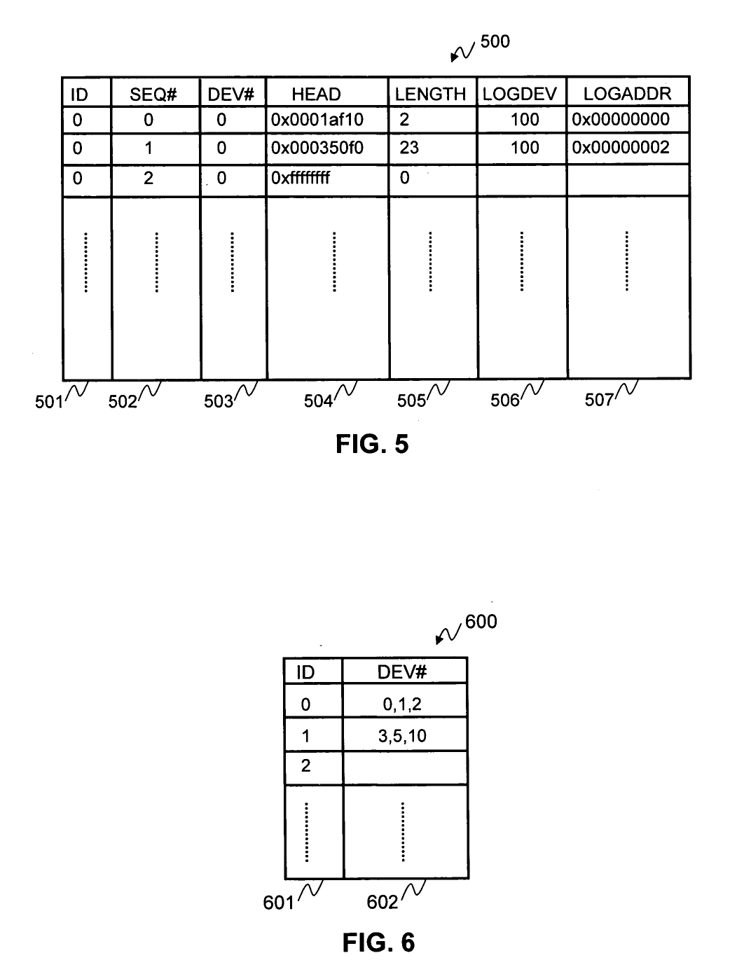

FIG. 5 illustrates a transaction list 500 in the present embodiment. A “transaction” is a unit of operation that is executed in the application 133. In the present embodiment, the transaction is defined by application 133. At the beginning of the transaction, AP 133 issues a request to the storage system 2 to let the storage system 2 know when the transaction starts (i.e., a “RequestTransaction” function). When the storage system 2 receives a request indicating the beginning of a transaction, any subsequent write I/O requests and write data that follow are initially stored into a log disk 312 instead of updating a primary volume 311. The write data in the log disk 312 is applied to the primary volume 311 when AP 133 instructs the storage system 2 to complete the transaction using the “commit” command described below.

Transaction list 500 is stored in cache memory 25 or memory 23. When a write I/O is received by the storage system 2, the write data is stored into the log disk 312 sequentially and the information about the write data is stored in the transaction list 500. Transaction list 500 includes fields for storing the following information:

ID 501: Each transaction has a unique identification number or identifier called the “transaction ID” that is stored in the field for ID 501.

SEQ# 502: The transaction monitor 232 needs to maintain and keep track of the write order of each write request (and write data) that is received by the storage system after a transaction starts. Thus, under the present embodiment, sequence numbers that start from 0 and increase sequentially are assigned to each write request in the present embodiment. The sequence number is stored in the field for SEQ# 502 for each transaction. Under other embodiments, other numbering or tracking systems may be used.

DEV# 503: This field contains the LDEV number of the logical device (i.e., a primary volume 311) that is designated in the write request as the intended recipient for storing the data.

HEAD 504: This field contains the address (logical block address or LBA) in the primary volume 311 that is designated in the write request as the target LBA for storing the data.

LENGTH 505: This field indicates the length of the write data that is designated in the write request.

LOGDEV 506: This field shows the logical device number of the log disk 312 where the write data corresponding to a particular SEQ# 502 is stored.

LOGADDR 507: This field shows the LBA in the log disk where the write data corresponding to a particular SEQ# 502 is stored. Thus, the combination of LOGDEV 506 and LOGADDR 507 can be used to identify the location in the log disk 312 where the write data is stored that corresponds to a write request identified with a particular SEQ# 502.

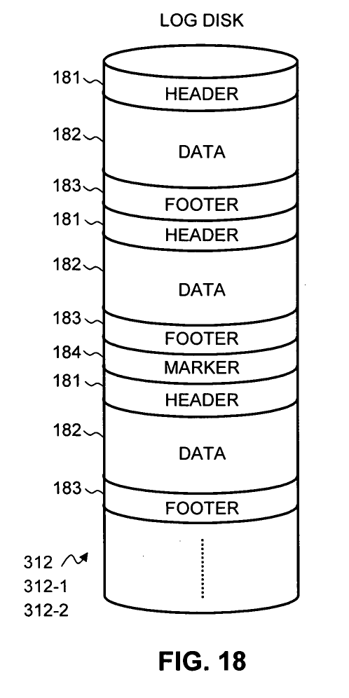

FIG. 18 illustrates the format of data stored in the log disk 312. Each data 182 is accompanied by a HEADER 181 and a FOOTER 183. HEADER 181 includes the write command information, which comprises SEQ# 502, DEV# 503, HEAD 504, and LENGTH 505 in the transaction list 500′. FOOTER 183 contains an error correcting code (ECC) and any padding data (so that the size of HEADER 181, data 182 and FOOTER 183 can be multiples of the size of a standard disk block (i.e., 512 bytes)). A MARKER 184 may also be stored with update data in log disk 312 when a commit command (described below) is issued. The MARKER 184 serves as an indication that a commit command was issued for a transaction, and that the data relating to that transaction may now be applied to the working volume.

Transaction Management Table

FIG. 6 illustrates a transaction management table 600 maintained in the storage system 2. When a command converted from a RequestTransaction function (described below) is received by the storage system 2, the controller 20 generates a unique transaction ID, and each logical volume specified by the command is registered on the transaction management table 600 with the generated transaction ID. Transaction management table 600 includes the transaction ID 601 and the device numbers (DEV#) 602 of the LDEVs that have write data designated to them by the particular transaction identified by the ID 601.

Transaction Processing APIs

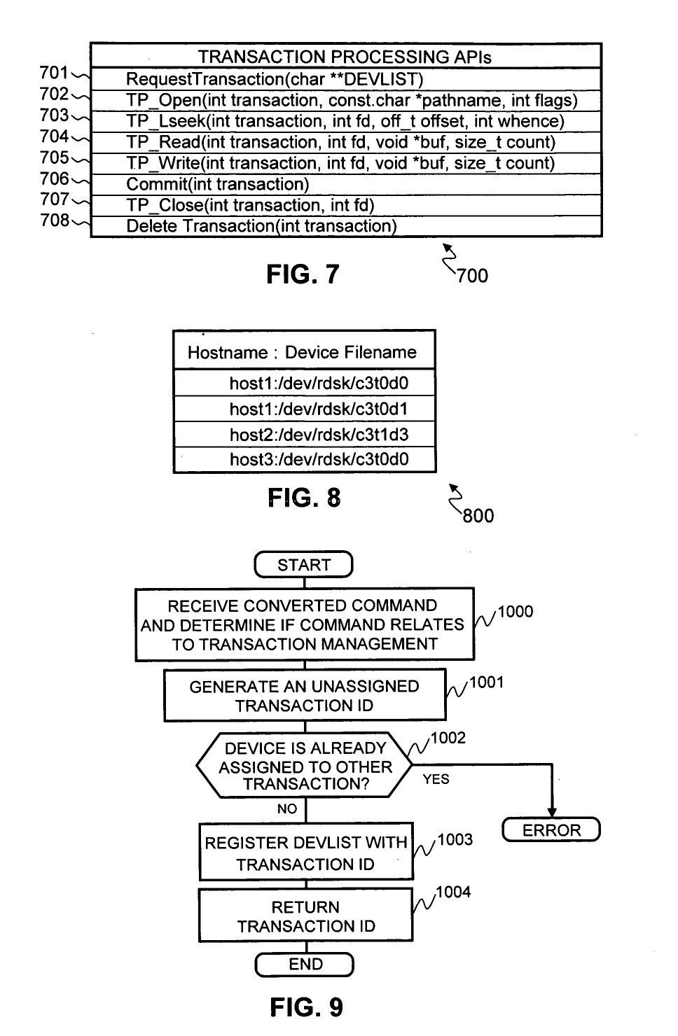

FIG. 7 illustrates a list 700 of transaction processing APIs (Application Programming Interfaces) that are provided by the transaction I/O driver 131, and which are provided as C-programming functions in the present embodiment. AP 133 uses these APIs to manage transactions and access primary volumes during transactions. When the transaction I/O driver 131 receives a request from AP 133 via these APIs, transaction I/O driver 131 converts each API function request into a command to the storage system 2. In the present embodiment, the proprietary commands which are based on the standard FCP-SCSI commands such as READ or WRITE are used between the transaction I/O driver 131 and the storage system 2. The API functions used in the present invention are as follows:

int RequestTransaction(char **DEVLIST) 701: When AP 133 initiates a transaction, AP 133 calls the RequestTransaction function to the storage system 2. In response, the storage system 2 returns a transaction number defined in the storage system 2 that will be used to identify the particular transaction. DEVLIST is an input parameter that tells the storage system 2 the list of primary volumes 311 that AP 133 will need to access while the transaction is running. As part of the DEVLIST, the list of device filenames should be specified. Further, as illustrated in FIG. 8, when a plurality of hosts 1 share a transaction, each line in the list 800 passed by the RequestTransaction function is composed of the hostname and device filename (such as “/dev/rdsk/c3t0d0”), as illustrated in FIG. 8, connected with a colon. When the transaction I/O driver 131 is called, it converts the list of the device filenames into the sets of the port address and LUN of the primary volumes, and sends this information (port address and LUN of the primary volumes) to the storage system 2. In the storage system 2, when the command converted from the RequestTransaction comes, the transaction I/O driver 131 generates a unique transaction ID, and each logical volume specified by the command is registered on the transaction management table 600 (FIG. 6) with the generated transaction ID.

int TP_Open(int transaction, const char *pathname, int flags) 702: This command is used before AP 133 accesses one of the primary volumes 311. The first input parameters “transaction” is the parameter to specify the transaction ID. The TP_Open function returns a file descriptor (fd) when it succeeds, which will be used for the functions that follow, such as in TP_Read or TP_Write functions. Other parameters (pathname and flag) used in the TP_Open function are the same as open system call functions in standard C-programming system calls. The pathname may be one of the device filenames, as designated in RequestTransaction function, or if OS 132 or AP 133 creates a file system on the logical device, and the logical device is one that was registered by the RequestTransaction function, the pathname can be one of the filenames in the logical device. It should be noted that more than one TP_Open function can be called per transaction.

off_t TP_Lseek(int transaction, int fd, off_t offset, int whence) 703: This function is similar to the standard Iseek system call except that the transaction ID needs to be specified as the first parameter. The TP_Lseek function is used with TP_Read or TP_Write function calls when AP 133 repositions the location of where to read or write the primary volume or the file. The repositioning is performed in accordance with a parameter “whence” such as the following (this is the same as standard Iseek system call):

SEEK_SET: The location to read/write data is set to “offset” bytes at the beginning of the primary volume 311 or the file.

SEEK_CUR: The location is set to the current location plus “offset” bytes.

SEEK_END: The location is set to the size of the file or volume plus “offset” bytes. For all three “whence” parameters, the location is managed by the transaction I/O driver 131 with each file descriptor “fd”.

ssize_t TP_Read(int transaction, int fd, void *buf, size_t count) 704: This function is similar to the standard read system call except that the transaction ID is specified as the first parameter. TP_Read function is used when AP 133 reads data from the primary volume during the transaction specified by the transaction ID. When the transaction I/O driver 131 receives a call of TP_Read function, the data read location (managed with file descriptor “fd”) and read data count (“count” parameter) is converted into the LBA and the number of blocks to be read from the primary volume, and a FCP-SCSI based command is issued in which READ command and transaction ID are combined.

ssize_t TP_Write(int transaction, int fd, void *buf, size_t count) 705: This function is similar to the standard write system call except that the transaction ID is specified as the first parameter. The TP_Write function is used when AP 133 writes data to the primary volume during the transaction specified with the transaction ID. When the transaction I/O driver 131 receives the call of the TP_Write function, the data write location (managed with file descriptor “fd”) and write data count (“count” parameter) is converted into the LBA and the number of blocks within which data is to be written in the primary volume, and the FCP-SCSI based command, including WRITE command and transaction ID, is issued. Within the storage system 2, the write data is stored in the log disks 312 and is not written to the primary volumes 311, but when the AP 133 reads data on the primary volumes specifying the same LBA as the write data using the TP_Read function 704, the write data is retrieved (that is, it appears to AP 133 as if the data has been written on the primary volume.)

int Commit(int transaction) 706: AP 133 calls this function at the end of the transaction after all the tasks associated with the particular transaction have been completed. The transaction ID needs to be specified as the input parameter. When the Commit function is called, the write data associated with the specified transaction ID in the log disks 312 is applied to the primary volumes 311. When the operation of applying the data to the primary volume in the storage system 2 is performed successfully, the commit function returns AP 133 the value “0”. When it fails for some reason, a “−1” is returned to indicate that error occurred during the Commit operation. When the function is called by AP 133, the transaction I/O driver 131 first writes all data associated with the transaction ID into the storage system 2 if there exists write data that has not yet been written to storage system 2, and then issues an instruction to the storage system 2 to apply the data to the primary volumes 311.

int TP_Close(int transaction, int fd) 707: Same as the close function in the standard C-programming system call except that the transaction ID is specified. The TP_Close function is used to close the file specified with the parameter “fd”.

void DeleteTransaction(int transaction) 708: AP 133 calls this function when the AP 133 wants to stop the transaction (specified at the transaction parameter) and roll back the transaction. The data that is written to the storage system 2 until the point when the function DeleteTransaction function is called is discarded by the storage system 2.

Process Flow—RequestTransaction

FIG. 9 illustrates the process flow of operation in the storage system 2 when the RequestTransaction 701 function is called at host 1. At first, transaction I/O driver 131 in host 1 converts the RequestTransaction function received from AP 133 into a FC-based command, and sends the converted command to the storage system 2. The following steps are then carried out by the storage system 2:

Step 1000: In the storage system 2, I/O process 233 receives the converted command. I/O process 233 determines if the received command is one of the transaction management commands described above, and, upon making an affirmative determination, passes the command to the transaction monitor 232.

Step 1001: When the transaction monitor 232 receives the command from I/O process 233, transaction monitor 232 generates an unused transaction ID by checking the transaction management table 600.

Step 1002: Transaction monitor 232 checks the list of the logical devices numbers received with the command to confirm if any of the received list of logical device numbers are already assigned to other transactions. This can be done by searching the transaction management table 600. If one of the logical devices specified by the command is already assigned to another transaction, the process terminates abnormally and returns an error. If none of the logical devices specified in the command are already assigned to another transaction, the process proceeds to step 1003.

Step 1003: Transaction monitor 232 registers the list of the logical device numbers in the command into the transaction management table 600 with the transaction ID that is generated at step 1001.

Step 1004: Transaction monitor 232 returns the transaction ID to host 1, and the process is complete.

Process Flow—TP_Write Request

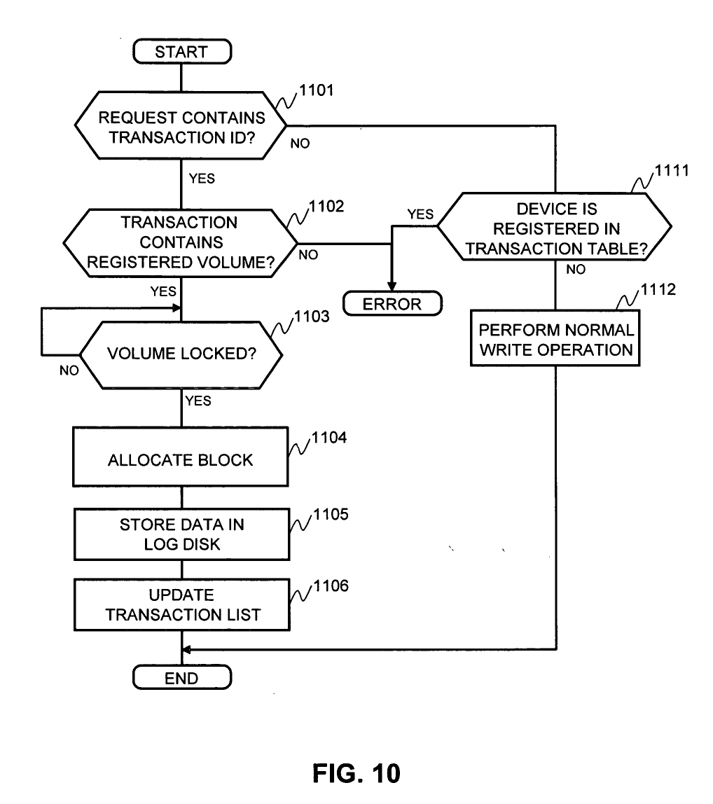

FIG. 10 illustrates the process flow of a TP_Write request 705, which includes the following steps:

Step 1101: I/O process 233 determines whether the command is a transaction management command and if the command contains a transaction ID. If the determination is affirmative, the process proceeds to step 1102. If the determination is negative, then the command is not related to the transaction management method of the invention or a particular transaction (i.e., it is a standard FCP-SCSI command such as WRITE), and the process goes to step 1111.

Step 1102: Transaction monitor 232 checks the parameters that come with the command to determine whether the designated logical device (i.e., the primary volume) is registered in the transaction management table 600 with the designated transaction ID. If the transaction management table 600 includes the designated logical device registered to the specified transaction ID, the process proceeds to step 1103. If not, the process ends abnormally and returns an error.

Step 1103: Transaction monitor 232 checks if the specified logical device is locked. If the specified primary volume is locked, the process waits until the logical device becomes unlocked. In other methods of implementation, the process may terminate and notify the host 1 that the device is locked without waiting for the specified logical device to become unlocked, or the process may return a locked notification to the host after waiting a predetermined period of time.

Step 1104: Transaction monitor 232 allocates an area in the log disk 312 where the write data is to be written (i.e., one or more blocks of available space). This step is a kind of locking process so that another write I/O process, such as from another application program in another host computer, does not overwrite data to the allocated area in this step.

Step 1105: Transaction monitor 232 stores the write data into the log disk 312.

Step 1106: Transaction monitor 232 adds the information about the write request that was executed at steps 1104 and 1105 to the transaction list 500, and then the process ends.

Step 1111: I/O process 233 determines whether the device designated by the write request is registered in the transaction management table 600. If the device is registered in the transaction management table 600, the process ends abnormally and returns an error since this means the device is part of a transaction, but the transaction ID was not included with the write request. If the device is not registered in the transaction management table 600, the process proceeds to step 1112.

Step 1112: The I/O process 233 performs normal write I/O processing and the process ends. In another embodiment, regardless of whether the designated logical device is registered or not in the transaction management table 600 when the normal WRITE command comes, the write request may be performed. However, in such a case, the consistency of the write data may not be preserved.

Process Flow—TP_Read Request

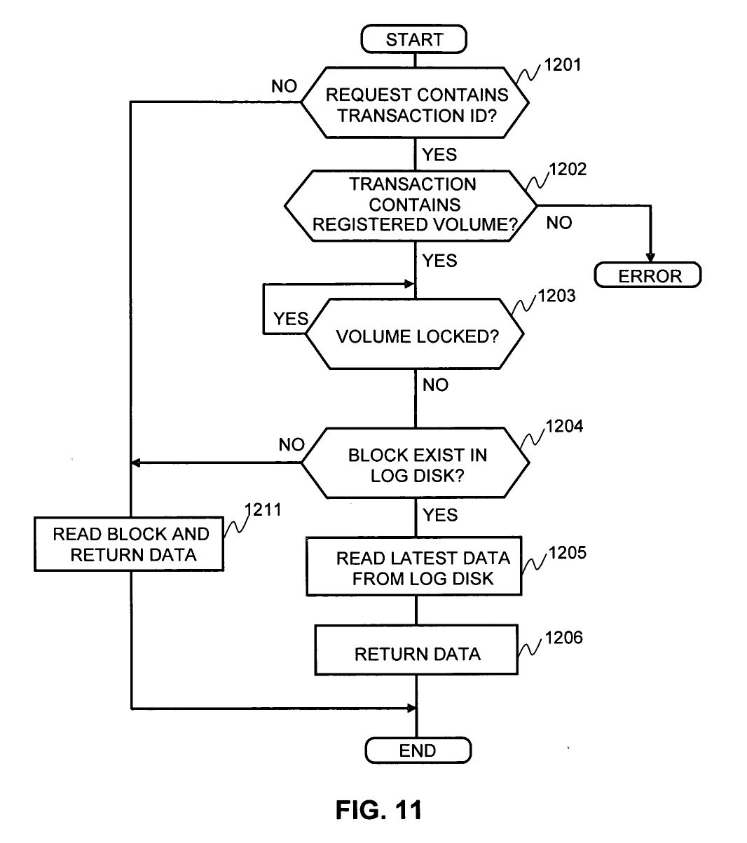

FIG. 11 illustrates the process flow when a TP_Read request is received in the storage system, and includes the following steps:

Step 1201: I/O process 233 determines whether the command is a transaction management command and whether the command contains a transaction ID. If the determination is affirmative, the process goes to step 1202. If the determination is that the command is not a transaction management command (i.e., it is a standard FCP-SCSI command such as READ), the process goes to step 1211.

Step 1202: Transaction monitor 232 checks the parameters that were included with the command to determine whether the designated logical device (i.e., the primary volume) is registered in the transaction management table 600 with the transaction ID specified in the command. If the designated logical device is registered, the process proceeds to step 1203. If not, the process ends abnormally and an error is returned to the host 1.

Step 1203: Transaction monitor 232 determines whether the logical device is locked. If the specified logical volume is locked, the process waits until the logical device becomes unlocked. In other methods of implementation, the process may terminate without waiting for the logical device unlocked and notifies host 1 that the logical device is locked, or the process may wait for a predetermined period of time before notifying the host that the device is locked.

Step 1204: Transaction monitor 232 determines whether the region (LBA) designated with the TP_Read command has been previously overwritten by a TP_Write command. If this is the case, then the updated data requested by the read request exists in the log disk 312 rather than in the primary volume 311. The data can be found by searching the contents of the transaction list 500. If the updated data exists in the log disk 312, the process proceeds to step 1205. If not, the process goes to step 1211.

Step 1205: Using transaction list 500, the process finds the latest updated data whose head 504 matches the LBA specified in the read request. Then transaction monitor 232 sends a read request to I/O process 233 instructing I/O process 233 to read data from log disk 312 at the LBA (LOGADDR 507) that corresponds in transaction list 500 to the LBA specified in the read request.

Step 1206: The I/O process 233 returns the read data to host 1.

Step 1211: I/O process 233 reads designated block and return the read data to host 1.

Process Flow—Commit Function

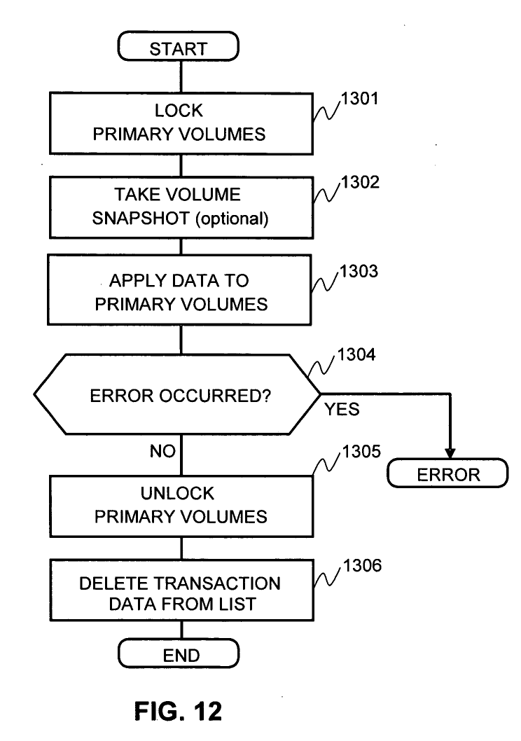

FIG. 12 illustrates the process for carrying out the Commit function, which includes the following steps:

Step 1301: The transaction monitor 232 locks the primary volumes 311 related to the particular transaction designated by the Commit function according to a particular transaction ID.

Step 1302: Transaction monitor 232 takes a snapshot of the one or more primary volumes. This operation is optional, and may use the COW technique discussed above. The advantage to taking the optional snapshot is to enable the recovery of data if the Commit function fails during execution because of some error (e.g., power failure in the storage system or other reason) which is not directly related to the application programs or the transaction monitor 232.

Step 1303: Transaction monitor 232 applies write data that is stored in the log disk 312 to the primary volume 311 in accordance with the write request information (elements 503, 504, 505, 506, 507) in the transaction list 500. To keep write order correct, the write operation is done in accordance with the sequence number SEQ# 502 for each write.

Step 1304: If an error occurs while the write data is being applied, the process terminates abnormally and an error is returned. If applying the data to the primary volume(s) 312 ends successfully, the process proceeds to step 1305.

Step 1305: Transaction monitor 232 instructs I/O process 233 to unlock primary volumes 311.

Step 1306: Transaction monitor 232 deletes the entries related to the designated transaction ID in the transaction list 500 and terminates the process normally. That is, all entries whose transaction ID 501 field is equal to the designated transaction ID are deleted from the list. After deleting the entries, the area in the log disk 312 where write data related to the corresponding transaction ID is stored will be used for storing data for other transactions. Also, in the present embodiment, the transaction ID is deleted in the storage system 2 after step 1306, and the deleted transaction ID may be reused when another RequestTransaction command is received by the storage system 2.

Should the commit function fail, or when AP 133 wants to roll back the changes made during the transaction before issuing the Commit function, then the DeleteTransaction function 708 is used. When the transaction monitor 232 receives the DeleteTransaction request from the transaction I/O driver 131, transaction monitor 232 deletes the entries related to the designated transaction ID in the transaction list 500, which is the same as the step 1305 in the Commit function set forth in FIG. 12. Also the transaction ID itself is deleted. Further, if the Commit function fails while executing the Commit function, the transaction monitor 232 updates the contents in the primary volume 311 with the contents in the snapshot volume 313, in addition to deleting the entries in the transaction list 500 to recover data before the Commit function is executed.

In the present embodiment, the disk region managed by each transaction is defined on a volume-by-volume basis. However, in another embodiment, the disk region managed by each transaction can be defined as partial volumes (such as by defining one or a plurality of contiguous disk blocks in a region specified by two LBAs within a volume).

### Second Embodiment

The hardware and software configuration in the second embodiment is the same as described above with respect to the first embodiment. The difference of the second embodiment from the first embodiment is in the management method of each transaction and the usage of transaction APIs, as follows:

int RequestTransaction(char **DEVLIST): When AP 133 calls the RequestTransaction function, the storage system 2 returns a transaction number defined in the storage system 2, as described above with respect to the first embodiment. The process of calling of the RequestTransaction function by AP 133 and the response of the storage system 2 are the same for the second embodiment as was described above in the first embodiment, such as in FIG. 9.

int open(const char *pathname, int flags): Instead of the TP_Open function 702 described above, the standard C-programming system call is used for the second embodiment.

off_t Iseek(int fd, off_t offset, int whence): Instead of TP_Lseek function 703 described above, the standard C-programming system call is used for the second embodiment.

ssize_t read(int fd, void *buf, size_t count): Instead of TP_Read function 704 described above, the standard C-programming system call is used for the second embodiment. Thus, under the second embodiment, within the storage system 2, if the READ command is targeted to a logical device that has been registered by a RequestTransaction function and the FC-SCSI READ command contains an LBA where the data is stored in log disk 312, the data is read from the log disk 312.

ssize_t write(int fd, void *buf, size_t count): Instead of TP_Write function 705 described above, the standard C-programming system call is used in the second embodiment. Thus, under the second embodiment, the write system call is converted to the FC-SCSI WRITE command and issued to the storage system 2. Within the storage system 2, if the WRITE command is targeted to a logical device that has been registered in the transaction management table 600 by a RequestTransaction function, the write data is stored in the log disks 312 and is not written to the primary volumes 311 until a Commit function is issued.

int Commit(int transaction): The Commit function in the second embodiment is similar to that described above with respect to the first embodiment. The difference from the first embodiment is that the transaction ID is not deleted from the transaction list 500 after Commit function is carried out.

int close(int fd): Instead of TP_Close function 707 described above, the standard C-programming system call is used in the second embodiment.

void DeleteTransaction(int transaction): The DeleteTransaction function in the second embodiment is similar to that described above with respect to the first embodiment. A slight difference will be described in the discussion below.

Process Flow—Write Request

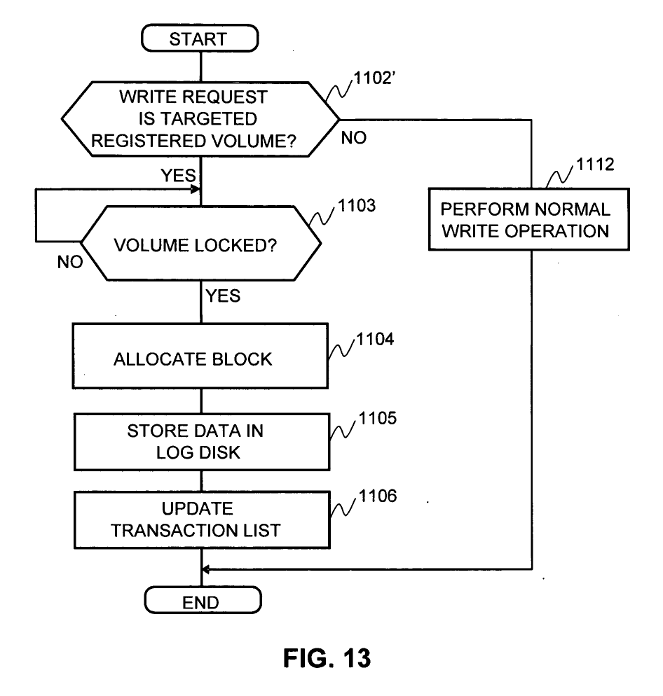

FIG. 13 illustrates a process flow of a write operation in the second embodiment of the invention. The difference from the first embodiment is that step 1101 in the first embodiment does not exist in FIG. 13 and that step 1102 is replaced by step 1102′.

In step 1102′, transaction monitor 232 determines whether the write request is targeted to one of the logical devices that has been designated by a RequestTransaction function or not. If the determination is affirmative, the process proceeds to step 1103 to perform the same write operations as described above with respect to FIG. 10 in the first embodiment. If the write request is not targeted to a logical device that has been designated by a RequestTransaction function, then the write operation does not need to be managed as part of a transaction, and the process goes to step 1112 to perform a normal write I/O operation, as described above with respect to FIG. 10 in the first embodiment. The remainder of FIG. 13 is the same as described above for FIG. 10, and does not need to be repeated here.

Process Flow—Read Request

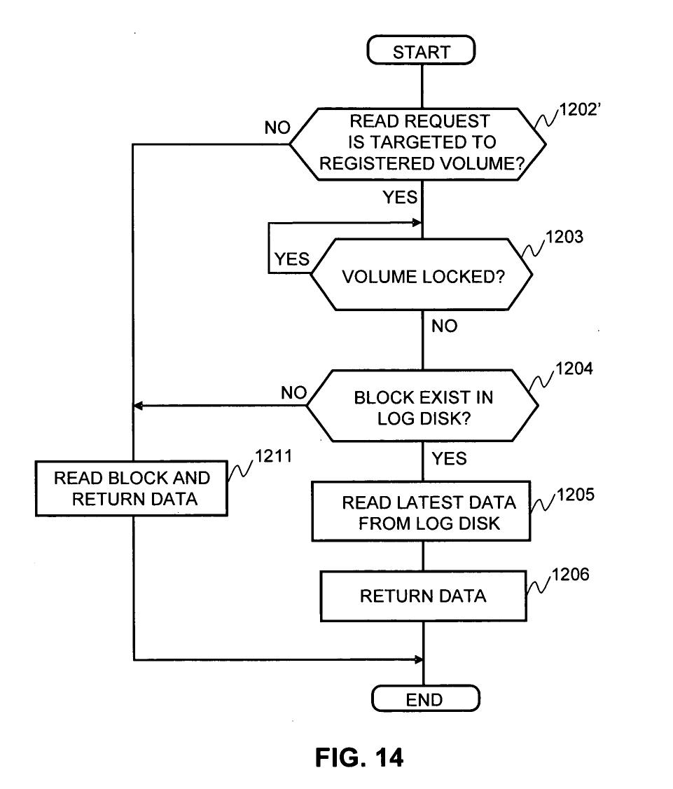

FIG. 14 illustrates the process flow of a read operation in the second embodiment. The difference from the first embodiment is that step 1201 in the first embodiment does not exist in FIG. 14 and that step 1202 is replaced by step 1202′.

In step 1202′, the transaction monitor 232 determines whether the read request is targeted to a logical device that has been designated by a RequestTransaction function or not. If the determination is affirmative, the process proceeds to step 1203 to perform the same read operation as described above with respect to FIG. 11 in the first embodiment. However, if the read request is not targeted to a logical device that has been designated by a RequestTransaction function, the process goes to step 1211 to perform a normal read I/O operation, as also described above. The remainder of FIG. 14 is the same as described above for FIG. 11, and does not need to be repeated here.

Commit Function

The commit function in the second embodiment is almost the same as in the first embodiment, as described above with respect to FIG. 12, except that the transaction ID is not deleted in the storage system 2 at step 1306. In the second embodiment, the transaction ID is deleted only when the DeleteTransaction function is called. Therefore, in the second embodiment, a user or AP 133 reuses the same transaction ID before a particular application program reaches a completion point, and calls the DeleteTransaction function after the Commit function when a particular application program reaches a completion point.

### Third Embodiment

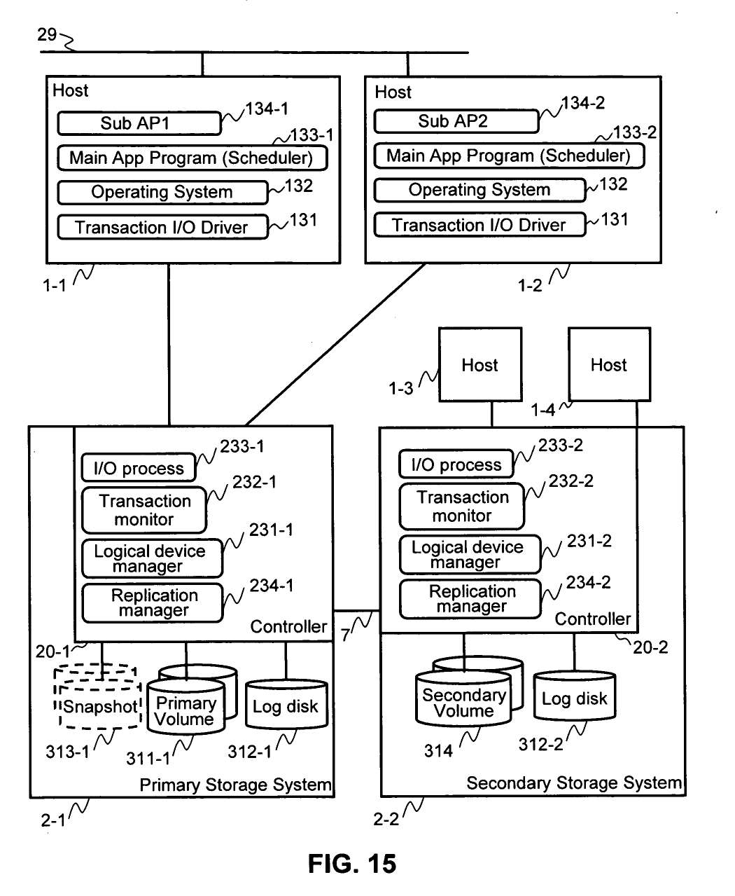

From the foregoing, it will be apparent that the present invention is useful for information systems where a plurality of application programs work cooperatively, and is especially is useful when recovering data in a consistent state at the beginning of, or at the end of a transaction in the application programs. As a third exemplary embodiment, FIG. 15 illustrates an example of how a plurality of application programs can work together using the technology of the present invention.

The system configuration in the third embodiment is similar to that of the first and second embodiments, except that a secondary storage system 2-2 is connected to a primary storage system 2-1. The hardware configuration of the primary storage system 2-1 and secondary storage system 2-2 may be the same as that of the storage system 2 described above in the first embodiment. However, an additional link 7 may be provided for copying data directly from the primary storage system 2-1 to the secondary storage system 2-2. Link 7 may be a Fibre Channel link, Ethernet, or other data communication medium. Further, with respect to the software configurations for storage systems 2-1, 2-2 and hosts 1-1, 1-2, the software modules are similar to those described above with reference to the first embodiment. However, storage systems 2-1, 2-2 each include a replication manager, 234-1, 234-2, respectively, for controlling replication from a primary volume 311-1 on primary storage system 1-1 to a secondary volume 314 on secondary storage system 2-2 for mirroring purposes, or the like. Further, host 1-1 includes a sub-application program (sub AP1) 134-1 that may be different from a sub AP2 134-2 included on host 1-2, as will be described in more detail below. The hardware structure of host 1-1 and 1-2 may be the same as the host 1 described above with respect to the first embodiment.

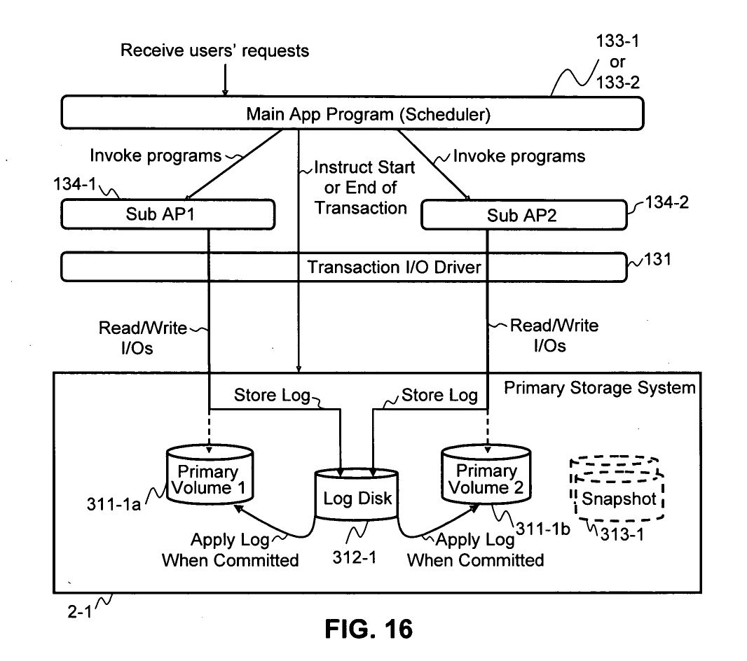

FIG. 16 illustrates the functional relation among software modules on hosts 1-1 and 1-2, as follows:

Main App Program (AP) 133-1 and 133-2: This is the basic application program of this embodiment, such as Web-based application programs, ERP (Enterprise Resource Planning) programs, and the like. AP 133 manages users' requests, invokes sub AP1 134-1 or sub AP2 134-2 to process I/Os in accordance with the users' requests, and the like. Also AP 133 controls the consistency of the data in the primary volumes 311-1a and 311-1b, etc, on primary storage system 2-1 and invokes sub-application programs. Thus, AP 133-1 and 133-2 may also be referred to as a “scheduler” or as having a task scheduler portion.

Sub AP1 134-1 and sub AP2 134-2: These programs are invoked by the scheduler of AP 133, and process read/write requests to the primary storage system 2-1. In the present embodiment, these programs generally do not have the transaction processing capability like commercial RDBMS programs.

When the scheduler of AP 133 receives a request from users, such as a purchase order (for example, if the scheduler of AP 133-1, 133-2 and sub AP1 134-1 and sub AP2 134-2 make up an online shopping application), APs 133-1 and 133-2 on hosts 1-1 and 1-2, respectively, instruct sub AP1 134-1 or sub AP2 134-2, respectively (in some cases, AP 133 on one of hosts 1-1 or 1-2 may instruct both AP 134-1 and 134-2), to process the request, such as checking for in-stock inventory, updating the inventory, updating an account database, etc. When each of sub AP1 134-1 and sub AP2 134-2 finishes the requests, it returns to the scheduler of AP 133 a notification that the particular request or step in the processing of the transaction is finished.

In the present embodiment, the scheduler of AP 133 knows the logical devices (or the portions of the logical devices) that sub APs 134-1, 134-2 use for storing data. Thus, before the scheduler of AP 133 issues the requests to sub APs 134, it issues the RequestTransaction function to the primary storage system 2-1 with the identification information of the logical devices (or the portions of the logical devices) that sub APs 134 use. After sub APs 134 finish their requests or tasks, the scheduler of AP 133 issues the Commit request to the primary storage system 2-1. Thus, the functionality illustrated in FIG. 16 is similar to the processes described above for the first and second embodiments, except that there are two primary volumes shown, with a primary volume 1 311-1a storing data from sub AP1 134-1, and a primary volume 2 311-1b storing data from sub AP2 134-2.

In the primary storage system 2-1, just as described above for the first embodiment or the second embodiment, after receiving the RequestTransaction function, storage system 2-1 stores any write data associated with a specified transaction into the log disk 312-1. When all tasks associated with a transaction have been completed successfully, and after receiving the Commit request from AP 133, storage system 2-1 applies the write data in the log disk 312-1 into the primary volumes 311-1 (311-1a and/or 311-1b). When one of the sub APs 134-1, 134-2 or the scheduler of AP 133 fails during the transaction, the scheduler of AP 133 issues a DeleteTransaction request to the primary storage system 2-1. When the primary storage system 2-1 receives the DeleteTransaction request, it discards the write data in the log disk 312 corresponding to the transaction ID specified in the delete request. Further, it is possible for there to be a plurality of sets of APs 133 having different schedulers and sub APs 134 in the system.

Remote Backup/Restore

In the third embodiment, the system may also include a secondary storage system 2-2 for mirroring the data in the primary storage system 2-1. The primary and secondary storage systems 2-1 and 2-2 have replication manager modules 234-1 and 234-2, respectively. When the primary storage system 2-1 or the primary site (i.e., consisting of the primary storage system 2-1 and at least one host 1 at the primary site) fails, the secondary site (i.e., the secondary storage system 2-2 and at least one host 1 at the secondary site) may take over the process under failover processing technology.

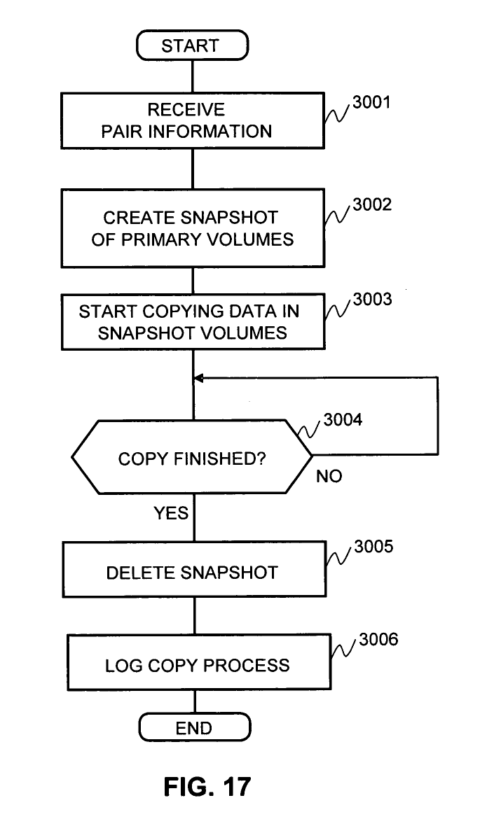

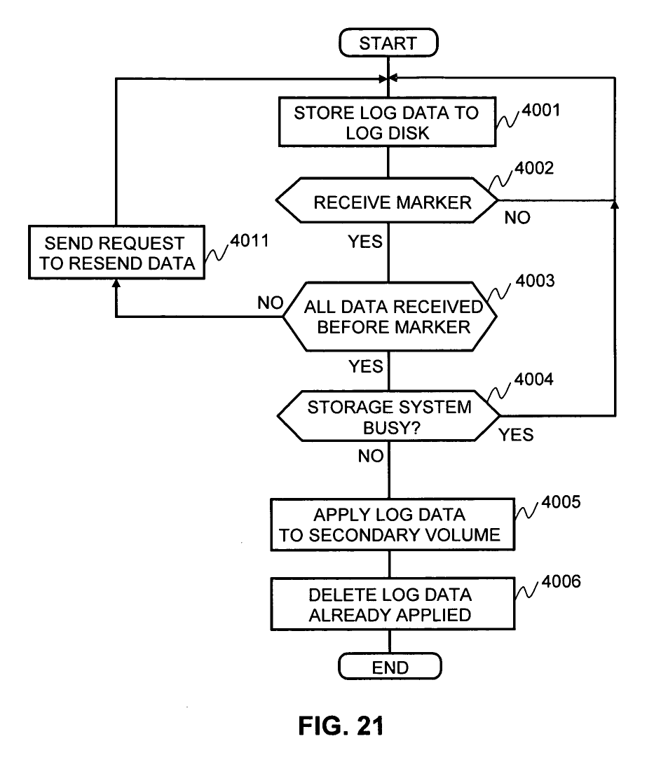

FIGS. 17 and 21 illustrate a process flow of the replication manager modules 234-1 and 234-2. The replication manager modules 234-1 and 234-2 exist and participate in each transaction. For example, when two transactions are defined in the primary storage system 2-1, two replication manager modules 234-1 work in the primary storage system 2-1, and two replication manager modules 234-2 work in the secondary storage system 2-2. Remote mirroring operations consist of two copy operations, an initial copy and an update copy. FIG. 17 illustrates the process flow of the initial copy operation of the replication manager 234-1, and FIG. 21 illustrates the process flow of the replication manager 234-2 when it receives the updated copy data.

When remote mirroring is started, users of the system issue the remote copy command via transaction I/O driver 131 to create a mirror in the secondary storage system 2-2 specifying the transaction ID, one or more primary volumes 311-1 in the primary storage system 2-1, and one or more destination or secondary volumes 314 where the data in the primary volumes 311-1 is mirrored (hereinafter called secondary volumes 314) in the secondary storage system 2-2. It should be noted that a secondary volume 314 in the secondary storage system 2-2 is treated similarly to a primary volume 311 under the invention, as described above in the first and second embodiments; however, the secondary volume receives data from the primary storage system, rather than from AP 131 on a host 1. A user may initially manually select/allocate the secondary volumes 314 so that the capacity of each secondary volume 314 is the same as or greater than that of the primary volume 311 which it will mirror. In another embodiment, when a user issues a command to create a mirror, one of the replication manager modules 234-1 and 234-2 can find the appropriate logical devices in the secondary storage system 2-2 to serve as secondary volumes 214.

Process Flow—Initial Copy

As illustrated in FIG. 17, when a request for creating a mirror is received, the replication manager 234-1 in primary storage system 2-1 carries out the following steps:

Step 3001: The replication manager 234-1 receives a request from host 1 to create a mirror. The request includes at least a transaction ID and pair information of at least one pair consisting of a primary volume 311-1 and a secondary volume 314 so that replication manager 234-1 can determine to which logical devices in the secondary storage system 2-2 the data in each primary volume 311-1 should be copied.

Step 3002: The replication manager 234-1 creates snapshot volumes 313-1 to take snapshots of each of the specified primary volumes 311-1. As a result, a point-in-time image of data in each of the primary volumes 311-1 is stored in the snapshot volumes 313-1. In the present embodiment, similar to the first embodiment, copy-on-write snapshot technology may be used to take snapshots, and thus, the snapshot data is virtually stored in the snapshot volumes 313

Step 3003: The replication manager 234 starts copying the data from the snapshot volumes 313 to the secondary volumes 314. The copying occurs from head LBA of the snapshot volumes 313 to the tail sequentially.

Step 3004: If all data is finished copying, the process proceeds to step 3005. If not, the process waits until all data is copied.

Step 3005: The replication manager 234-1 deletes the snapshot volumes 313-1 and the initial copy step is completed.

Step 3006: After copying all data, the replication manager 234-1 starts the update copy operation. The update copy operation in this embodiment can be performed by copying the data in the log disk 312-1 to a secondary log disk 312-2 in secondary storage system 2-2.

The initial copy process in the secondary storage system 2-2 is managed by the replication manager 234-2. Replication manager 234-2 receives the initial copy data from the primary storage system 2-1, and stores the initial copy data into the secondary volume 314.

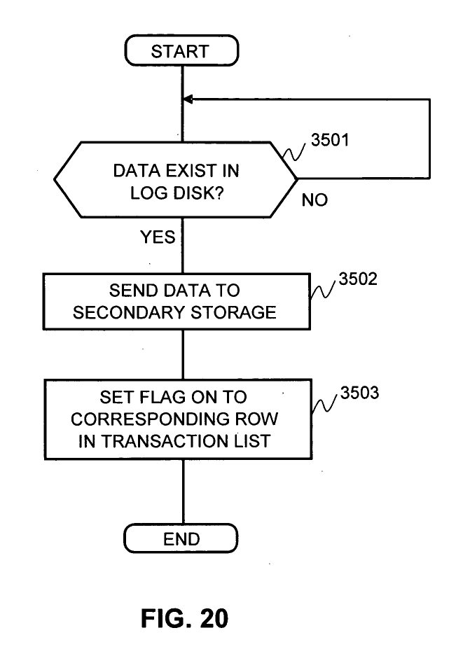

The update copy operation in the primary storage system 2-1 is also performed by the replication manager 234-1 by sending the data in the log disk 312-1 periodically to the secondary storage system 2-2 To avoid having data in the log disk 312-1 deleted by the transaction monitor 232, the log data deletion process is carried out only if the replication manager 234 permits data to be deleted from the log disk 312-1 after the data in the log disk 312-1 is copied to the secondary log disk 312-2 in storage system 2 by the replication manager 234, as described below with reference to FIG. 20.

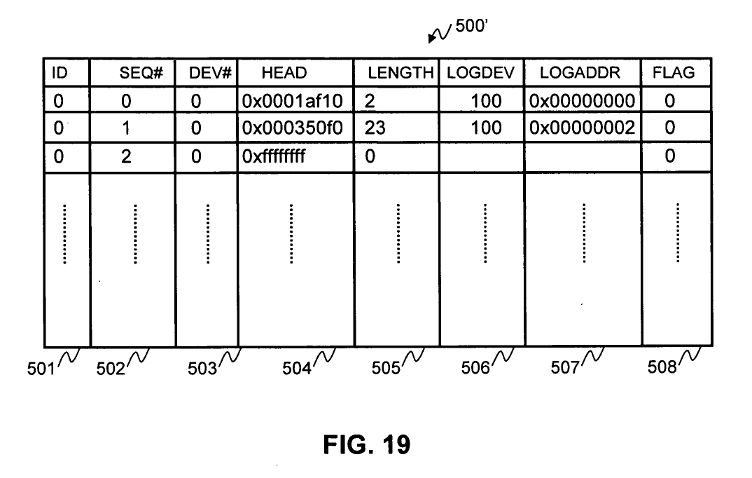

FIG. 19 illustrates the transaction list 500′ that is used in the present embodiment. The difference of the transaction list 500′ from the first embodiment is that a FLAG 508 column is added. If the value of FLAG 508 is “1”, it means that the corresponding data in the log disk 312-1 has already been transmitted to the secondary storage system 2-2 by the update copy operation. If the data has not yet been transmitted to the secondary storage system 2-2, the value of FLAG 508 is “0”, and the data is protected from deletion until it has been transferred.

Process Flow—Update Copy in Primary Storage System

FIG. 20 illustrates the process flow of update copy in the primary storage system 2-1. The process works periodically (such as once a minute), and includes the following steps:

Step 3501: Replication manager 234 checks the transaction list 500′ to determine whether there is data that has not yet been sent to the secondary storage system 2-2. Such data can be found by checking whether the FLAG 508 is “0” or “1”. If there are entries whose FLAG 508 are “0”, the process proceeds to step 3502. If not, the process waits until the next cycle to determine whether new data has been written to the log disk 313-1.

Step 3502: Replication manager 234 sends data having a FLAG 508 of “0” to the secondary storage system 2-2. It is possible that a plurality of write datum is sent to the secondary storage system 2-2, but not all data whose FLAG 508 is “0” have to be sent at the same time. When there are a lot of data entries to be sent, the data may be sent by a plurality of update copy operations. Further, the order for sending each write data need not be kept, though the data is usually sent in accordance with its sequence number (SEQ# 502).

Step 3503: When the data is sent to the secondary storage system 2-2 and replication manager 234-1 receives acknowledgement from the secondary storage system 2-2, replication manager 234-1 sets the FLAG 508 to “1” in each entry of the transaction list 500′ that has been sent to storage system 2-2.

When the data is sent to the secondary storage system 2-2, the write command information is also sent. FIG. 18 illustrates the format of data stored in the log disk 312-2 in the secondary storage system 2-2. As with log disk 312 described above, each data 182 is accompanied by a HEADER 181 and a FOOTER 183. HEADER 181 includes the write command information, which comprises SEQ# 502, DEV# 503, HEAD 504, and LENGTH 505 in the transaction list 500′. However, as for DEV# 503, the value itself that is in the DEV# 503 field is not sent. Instead, the corresponding logical device number in the secondary volume 314 (the volume in the secondary storage system 2-2, which is in pair relation with the primary volume 311, and wherein the data coming from the primary storage system 2-1 is to be written) is sent. A MARKER 184 may also be stored with update data in log disk 312-2 when a commit command is issued. The MARKER 184 serves as an indication that a commit command was issued for a transaction, and that the data relating to that transaction may now be applied to the working volume, which in this case is the secondary volume 314.

As stated above, the secondary volume 314, may be allocated manually by a user. In another embodiment, secondary volume 314 may be determined automatically by the primary storage system 2-1 or secondary storage system 2-2 using known remote copy techniques.

Process Flow—Update Copy in Secondary Storage System

FIG. 21 illustrates the process flow of update copy in the secondary storage system 2-2. The process in the secondary storage system also is performed periodically, and includes the following steps:

Step 4001: The replication manager 234-2 receives update data from the primary storage system 2-1 and stores the data into log disk 312-2.

Step 4002: If replication manager 234-2 receives a MARKER 184 at step 4001, the process proceeds to step 4003. If not, the process goes back to step 4001 to wait for additional data.

Step 4003: Replication manager 234-2 checks whether all data from the beginning of the particular transaction and end of the particular transaction (including MARKER 184) has been received. If all data has been received, the process proceeds to step 4004. If not, the process goes to step 4011 to request the primary storage system 2-1 to re-send data that has not arrived at the secondary storage system 2-2.

Step 4004: If the secondary storage system 2-2 is busy performing other tasks, the process returns to back to step 4001. If not, the process proceeds to step 4005.

Step 4005: The replication manager 234-2 instructs the transaction monitor 232-2 to apply data in the secondary log disk 312-2 to the secondary volume 314.

Step 4006: The replication manager 234-2 instructs the transaction monitor 232-2 to delete data in the secondary log disk 312-2 that has been applied to the secondary volume 314.

Step 4011: If all data the forms part of a transaction has not been received, replication manager 234-2 sends a request to the primary storage system 2-1 to re-send data that has not arrived at the secondary storage system 2-2.

When the primary site fails, under typical failover procedures, a user attempts to restart the application programs at the secondary site. At the secondary site, before restarting the application programs, the user issues a Commit function from one of the hosts 1-3, 1-4 at the secondary site to the secondary storage system 2-2. When the secondary storage system 2-2 receives the request, the secondary storage system 2-2 applies data in the log disk 312-2 to the secondary volume 314 sequentially if there are data in the log disk 312-2 that have not yet been applied to the secondary volume 314. But the data that is applied to the secondary volume 314 is limited to the transaction data of which all data from the beginning of a transaction through the end of the transaction has arrived at the log disk 312-2. Other data in log disk 312-2 for which the transactions are incomplete is discarded. Under this procedure, when restarting application programs at the secondary site, the application programs can access the data at the point just at the beginning of the transactions that were not completed when the primary site failed.

Thus, from the foregoing, it may be seen that the storage systems of this invention have a means for receiving information regarding the beginning of a transaction and the end of a transaction from application programs. When the storage systems receive notification indicating the beginning of transaction, the update I/O operations are recorded to a log disk, and when the storage systems receive notification of the end of transaction, the recorded data in the log disks may be committed to the working volume. By this means, the invention provides a way to handle I/O transactions in a storage system and to provide basic infrastructure for application programs to manage transactions.

Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of managing transactions of application programs at a storage system comprising the steps of:
(a) receiving, at the storage system, an instruction indicating a beginning of a first transaction;
(b) determining at least one primary volume for receiving data for the first transaction;
(c) providing a log volume for initially storing write data designated for said primary volume for said first transaction;
(d) receiving at the storage system, an instruction indicating a completion of the first transaction, and
(e) after step (d), writing the data stored in the log volume for said first transaction to said at least one primary volume.

2. The method of claim 1, further including before step (d):
if a read request to data of the at least one primary volume corresponds to data stored in the log volume and not yet written to the at least one primary volume, the corresponding data stored in the log volume is retrieved so that data is presented to an application program as if it is contained in the at least one primary volume.

3. The method of claim 1, further including after step (a):
returning a notification if any logical devices required for the first transaction are used by a second transaction that is already in progress.

4. The method of claim 1, further including after step (a):
determining whether a write request is for the first transaction or a normal write request by determining whether a transaction identifier is included with the write request.

5. The method of claim 1, further including after step (a):
determining whether a write request is for the first transaction or a normal write request by determining whether a logical device designated in the write request has been identified as a write target for the first transaction.

6. The method of claim 1, further including after step (c):
updating an information following each write to the log volume to correlate an actual storage location of the data in said log volume with a target storage location of the data in said first primary volume.

7. The method of claim 1, further including after step (d):
creating a snapshot of the primary volume prior to starting step (e).

8. A method for storing data in a first storage system having a first primary volume, a second primary volume and at least one log disk, wherein at least one host is in communication with the storage system, said at least one host having a first application program for execution thereon, said method comprising:
generating a transaction identifier for a transaction;
receiving by said first storage system a first write data for said transaction from a first sub-application invoked by said first application program, said first sub-application sending data to the first primary volume;
receiving by said first storage system a second write data for said transaction from a second sub-application invoked by said application program, said second sub-application sending data to the second primary volume;
storing said first write data and said second write data in a log volume;
receiving an instruction indicating that said transaction is complete; and
applying said first write data to said first primary storage volume and said second write data to said second primary storage volume following completion of said transaction.

9. The method of claim 8, further including the steps of:
receiving a read request prior to receiving the instruction that the transaction is complete; and
determining whether said read request is for the transaction that is not yet complete;
wherein, if the read request is for the transaction that is not yet complete, and if an address for requested data points to a location in the first or second primary volume that has been updated since the beginning of the transaction, then a most recent version of the requested data is read from the log volume and returned in response to the read request.

10. The method of claim 9, further including the steps of:
determining whether said read request is for the transaction by:
determining whether the transaction identifier was included with the read request, and/or
by determining whether a logical device targeted by the read request is designated for the transaction.

11. The method of claim 8, further including the steps of:
providing a second storage system in communication with the first storage system having at least one secondary volume for receiving remote copy of at least one of said first or second primary volumes and at least one secondary log volume;
sending update data from said log volume to said secondary log volume; and
upon receiving notification of completion of the transaction, applying the data in the secondary log volume related to the transaction to the secondary volume.

12. The method of claim 11, further including the steps of:
if a failure occurs at the location of the first storage system, restarting a second application program on a second host having access to the second storage system;
deleting from the secondary log volume data for transactions that have not been completed; and
applying to said secondary volume data from the secondary log volume for transactions that have been completed.

13. The method of claim 11, further including the steps of:
performing initial copy of data from the at least one primary volume to the at least one secondary volume by creating a snapshot of each primary volume; and
copying data from the snapshot volume to a secondary volume forming a mirror pair with the primary volume.

14. The method of claim 11, further including the steps of:
tracking whether data has been copied from the log volume to the secondary log volume; and
preventing deletion of information related to said transaction following completion of the transaction until all data for the transaction has been copied to said secondary log volume.

15. The method of claim 8, further including the step of:
including the transaction identifier with each write request related to said transaction so that the storage system is able to determine that the write requests are for the transaction.

16. The method of claim 8, further including the step of:
checking by the first storage system whether each write request is related to said transaction by determining whether a targeted logical device is designated for the transaction.

17. A system comprising:
a first storage system including a controller and at least one storage device; and
a first host in communication with said first storage system, including a first application running on said first host,
wherein a first module running on the host requests the storage system to generate a transaction identifier for a transaction initiated by said application;
wherein a second module running on the storage system determines whether a write request is for the transaction,
wherein when a first write request is for the transaction, the second module causes first write data to be initially stored to a log volume instead of to a first primary volume that is a target of the first write request, and
wherein when a plurality of tasks have been performed so that the transaction is completed successfully, the second module receives a notification from the first module to apply the first write data for the transaction from the log volume to the first primary volume.

18. The system of claim 17,
further including a second host in communication with the at least one storage system, with a second application running on said second host, said second application being invoked as part of said transaction; and
further including a second primary volume on said first storage system as a target of data written by the second host,
wherein when said second host issues a second write request to said storage system as part of said transaction, said second storage system stores second write data to said log volume, and
wherein when the transaction is completed successfully, the second module receives a notification from the first module to apply the second write data for the transaction from the log volume to the second primary volume.

19. The system of claim 17,
wherein when the second module receives a read request for the transaction, the second module determines whether data requested to be read has been updated as part of the transaction and stored to said log volume;
wherein if the data requested has been stored to the log volume, the second module causes a most recent version of the requested data to be read from the log volume and returned in response to the request.

20. The system of claim 17, further including
a second storage system in communication with the first storage system, said second storage system including a secondary volume and a secondary log volume;
wherein a remote copy function is established between said first primary volume on the first storage system and the secondary volume on the secondary storage system;
wherein update data on the log disk on the first storage system is copied to the secondary log disk on the second storage system; and
wherein upon receiving notification of completion of the transaction, the update data on the secondary log disk for the transaction is applied to the secondary volume.
